(19) United States
(12) Patent Application Publication
(10) Pub. No.: US 2025/0044523 A1
(43) Pub. Date: Feb. 6, 2025

(54) Optical Waveguide Substrate, Optical Device and Manufacturing Method of Optical Device

(71) Applicant: Nippon Telegraph and Telephone Corporation, Tokyo (JP)

(72) Inventors: Takashi Yamada, Musashino-shi, Tokyo (JP); Kiyofumi Kikuchi, Musashino-shi, Tokyo (JP); Yuriko Kawamura, Musashino-shi, Tokyo (JP)

(21) Appl. No.: 18/716,821

(22) PCT Filed: Dec. 9, 2021
(86) PCT No.: PCT/JP2021/045370

§ 371 Date: Jun. 5, 2024

(51) Int. Cl. G02B 6/36; G02B 6/04; G02B 6/42

(52) U.S. Cl. CPC G02B 6/3636; G02B 6/04; G02B 6/3616; G02B 6/4243

(57) ABSTRACT

An optical waveguide substrate, which includes a substrate main body; and an optical waveguide formed in the substrate main body, is configured in a manner that the substrate main body includes a through-hole which includes one end surface of the substrate main body and penetrates the substrate main body in a thickness-wise direction, and a long groove portion which communicates with the through-hole and extends in parallel with a main surface of the substrate main body, the through-hole is formed at a position corresponding to the optical waveguide, and an inner surface of the long groove portion includes an inclined surface which is in contact with an optical fiber when the optical fiber is inserted through the long groove portion via the through-hole.

### TECHNICAL FIELD

The present invention relates to an optical waveguide substrate, an optical device, and a method for manufacturing the optical device.

### BACKGROUND ART

An optical waveguide structure using silicon photonic technology is formed by depositing SiO₂ on a silicon substrate, depositing a silicon layer in SiO₂, and etching the silicon layer into a desired pattern by photolithography technology. Wires of driving devices for photodiodes and a pad for fixing the substrate are provided on the surface of the silicon substrate. The wires and the pad are formed of, for example, a metal layer of aluminum, gold, or the like. In order to input/output optical signals to/from such a silicon photonic optical waveguide substrate, it is necessary to optically polish the end surfaces of the optical waveguide of the silicon substrate and connect a plurality of optical fibers to each optical waveguide according to a function of an optical circuit.

The known optical polishing, like the polishing process for other metal products, is carried out through a rough polishing process, a medium polishing process and a finish polishing process using fine silica particles by changing the kind and size of polishing abrasive grains, and requires a large-scale polishing apparatus and a large amount of working time. In addition, since the layer above the silicon waveguide layer of the optical waveguide substrate is as very thin as about several μm, small notches or cracks are likely to be generated in the upper layer of the substrate due to chipping generated in the optical polishing process. When the notches reach the end surface of the optical waveguide, a large optical connection loss is caused when the optical fibers are connected.

In addition, when the optical fibers are connected and fixed to the end surfaces of the optical waveguide, a plurality of optical fibers are optically aligned and fixed collectively using an optical fiber array. The optical fiber array is configured to align the optical fibers with high accuracy in accordance with the interval between the optical waveguides at the time of connection. The connection of the optical fibers by the optical fiber array is performed by disposing the optical fibers from which the coating has been removed on a glass substrate that has been subjected to V-grooving, pressing the glass substrate so that the optical fibers are brought into close contact with the slope surfaces of the V-grooves, and further covering the coated portion of the optical fibers with a protective resin on an opposite side to the optical connection surface. Such optical fiber connection can improve the bending resistance of the optical fibers and prevent the optical fibers from slipping out of the V-groove. If the optical end surface of the optical fiber array is optically polished, the angle of the optical end surface can be freely adjusted.

### CITATION LIST

### Non Patent Literature

Non Patent Literature 1: NTT Advanced Technology Corporation, Internet, Web page URL: https://keytech.ntt-at.co.jp/optservice/prd_0029.html, Accessed on Nov. 29, 2021.

### SUMMARY OF INVENTION

However, there is room for improvement in that the above-described configuration requires a relatively long time for polishing. Specifically, in the optical alignment process using the optical fiber array, in order to achieve low-loss optical connection, it is necessary to perform parallelism alignment and interval adjustment between connection end surfaces of the optical fiber array and the optical waveguide substrate, optical axis alignment based on active alignment, and fixing by an adhesive using an ultraviolet curable adhesive. Then, the processing time from the installation of the members to the alignment and the ultraviolet curing of the adhesive is 10 minutes or more.

In addition, the silicon photonic optical waveguide substrate is mounted on a control substrate as a main component of an optical transceiver. Flip-chip mounting via gold bumps or copper pillars provided on the surface of the optical waveguide substrate is mainly used. Since the flip-chip mounting includes a heating process or the like, it is desirable that there is no optical fiber. Therefore, it is preferable to connect the optical fibers after the flip-chip mounting. However, there arises a problem that when the optical fibers are connected after mounting, it is difficult to visually recognize the optical waveguides connected to the optical fibers. That is, the optical waveguide substrate is turned upside down after mounting, and it is difficult to confirm the surface (upper surface) of the side on which the optical waveguide can be visually recognized.

As described above, the known active alignment method for the end surfaces of the optical waveguide in the optical fiber array includes complicated processes from the manufacturing including the polishing process to the alignment and fixing, raising issues on the manufacturing time and cost. Further, the flip-chip mounting should address a problem such that it is difficult to confirm the position of the optical waveguide at a stage before the active alignment. The present disclosure has been made in view of such regards, and relates to an optical waveguide substrate, an optical device, and a method for manufacturing the optical device, wherein the time required for manufacturing including a polishing process and for aligning optical fibers is shortened, and the optical waveguide can be easily confirmed at the time of connection with optical fibers after mounting.

To achieve the above-described object, an optical waveguide substrate according to one aspect of the present disclosure includes: a substrate main body; and an optical waveguide formed in the substrate main body, the substrate main body including a through-hole which includes one end surface of the substrate main body and penetrates the substrate main body in a thickness-wise direction, and a long groove portion which communicates with the through-hole and extends in parallel with a main surface of the substrate main body, the through-hole being formed at a position corresponding to the optical waveguide, and an inner surface of the long groove portion including an inclined surface which is in contact with an optical fiber when the optical fiber is inserted through the long groove portion via the through-hole.

An optical device according to one aspect of the present disclosure includes: the optical waveguide substrate; and an electronic circuit that is mounted on a mounting surface which is a main surface of the optical waveguide substrate, the inclined surface of the through-hole being inclined toward the mounting surface from a center line which is in the direction of the extending of the long groove portion.

A method for manufacturing an optical device according to one aspect of the present disclosure that includes an optical waveguide substrate including a substrate main body and an optical waveguide formed on the substrate main body, and a plurality of optical fibers aligned and connected to the optical waveguide, the substrate main body including a through-hole which includes one end surface of the substrate main body and penetrates the substrate main body in a thickness-wise direction, and a long groove portion which communicates with the through-hole and extends in parallel with a main surface of the substrate main body, the method includes: aligning the plurality of optical fibers with the through-hole; translating the plurality of optical fibers, which have been aligned, along the long groove portion; and fixing the plurality of optical fibers inside the long groove portion.

A method for manufacturing an optical device according to one aspect of the present disclosure that includes an optical waveguide substrate and a plurality of optical fibers aligned and connected to an end surface of the optical waveguide substrate, the optical waveguide substrate including a through-hole which includes the end surface, penetrates the optical waveguide substrate in a thickness-wise direction, and is formed at a position corresponding to an optical waveguide of the optical waveguide substrate, and a long groove portion which communicates with the through-hole, extends in parallel with a main surface of the optical waveguide substrate, and has an inner surface including an inclined surface which is in contact with the optical fibers, the method includes: aligning the plurality of the optical fibers with the through-hole; translating the plurality of the optical fibers, which have been aligned, along the long groove portion; and fixing the plurality of the optical fibers inside the long groove portion.

According to the above-described aspects, it is possible to provide an optical waveguide substrate, an optical device, and a method for manufacturing the optical device, wherein the time required for manufacturing including a polishing process and for aligning optical fibers is shortened, and the optical waveguide can be easily confirmed at the time of connection with optical fibers after mounting.

### BRIEF DESCRIPTION OF DRAWINGS

FIG. 1 is a bottom perspective view of an optical device according to one embodiment of the present disclosure.

FIG. 2 is a top perspective view of the optical device shown in FIG. 1.

FIG. 3 is an enlarged top perspective view of a part shown in FIG. 1.

FIG. 4(a) is a top view of an optical fiber connection portion, FIG. 4(b) is a vertical sectional view of the optical fiber connection portion, and FIG. 4(c) is a horizontal sectional view of the optical fiber connection portion.

FIG. 5(a) is a bottom view of an optical waveguide substrate, and FIG. 5(b) is a horizontal sectional view of the optical waveguide substrate.

FIGS. 6(a), 6(b), and 6(c) are views for describing a manufacturing process of the optical device.

FIGS. 7(a), 7(b), and 7(c) are views for describing the manufacturing process of the optical device following FIG. 6(c).

FIG. 8 is a top perspective view of the optical device shown in FIG. 7(b).

### DESCRIPTION OF EMBODIMENTS

Hereinafter, one embodiment of the present disclosure will be described. The drawings used in the description of the present embodiment are intended to describe the technical concept, components, arrangement and relation of the components of the present disclosure, and do not necessarily accurately show the specific shape, size, ratio of length, width and thickness of the present disclosure.

### (Optical Device)

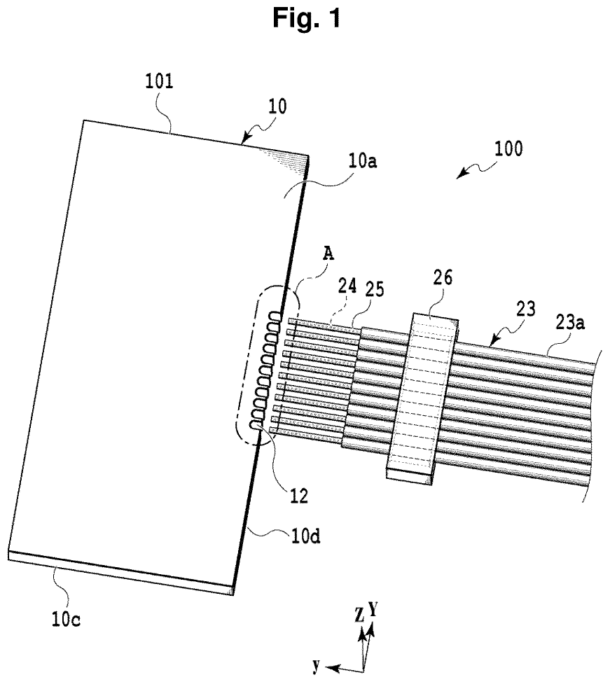

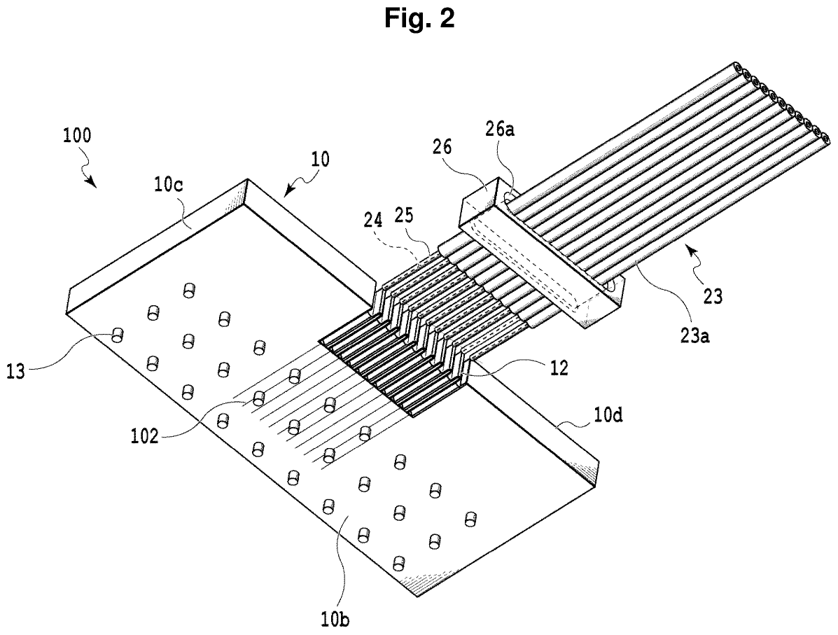

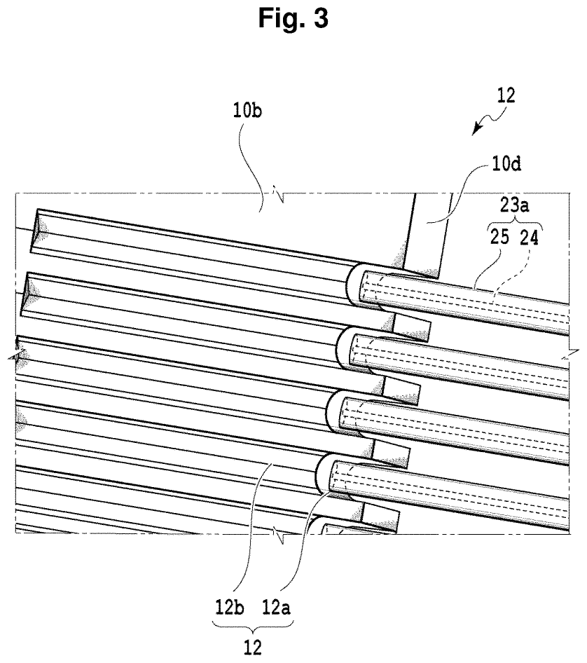

FIG. 1 is a bottom perspective view of an optical device 100 according to one embodiment of the present disclosure, FIG. 2 is a top perspective view of the optical device 100 shown in FIG. 1, and FIG. 3 is an enlarged top perspective view of a range A shown in FIG. 1. An upper surface and a lower surface of the present embodiment are defined by the coordinate system in FIG. 1, and a side having a larger z-axis coordinate is referred to as “upper” or “upper side” with respect to another side having a smaller z-axis coordinate. In addition, the side having a smaller z-axis coordinate is referred to as “lower” or “lower side” with respect to the side having a larger z-axis coordinate. A lower surface 10a is a surface of an optical waveguide substrate 10 of the optical device 100 opposite to a surface on a side from which an unillustrated optical waveguide can be seen. An upper surface 10b corresponds to a back surface of the lower surface 10a. Surfaces between the upper surface 10b and the lower surface 10a are referred to as side surfaces 10c. Among the side surfaces 10c, a side surface on a side connecting an optical fiber 23a is particularly referred to as an end surface 10d. Thus, the reason why the side having a larger z-axis coordinate is referred to as the lower surface 10a and the side having a smaller z-axis coordinate is referred to as the upper surface 10b is that the connection and alignment of the optical fiber 23a according to the present embodiment are performed by reversing the top and bottom of the optical waveguide substrate 10. The perspective views of FIGS. 1, 2, and 3 all show a state in which the optical fiber 23a is close to the end surface 10d, and do not show a state in which the optical fiber 23a is connected to the optical waveguide in the optical waveguide substrate 10.

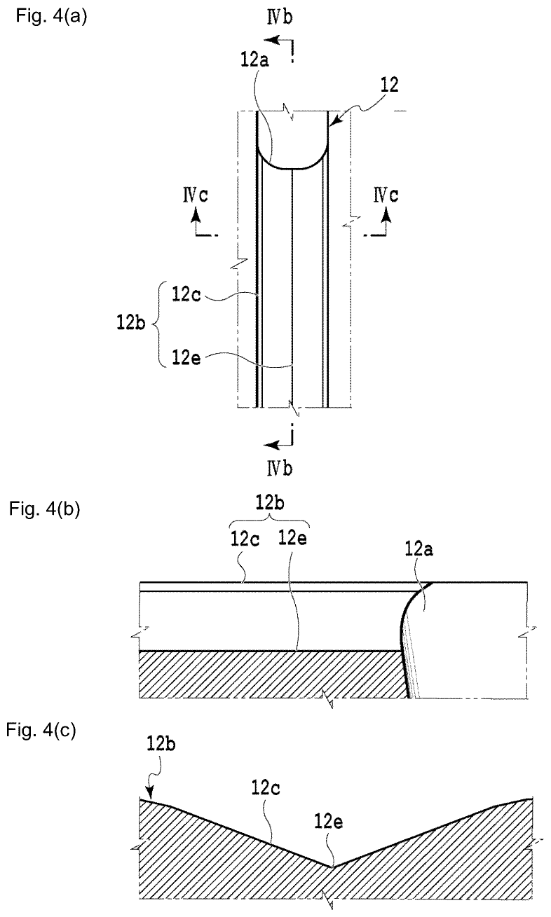

As shown in FIGS. 1 to 3, the optical waveguide substrate 10 includes a substrate main body 101 and an optical waveguide 102 formed on the substrate main body. The substrate main body includes a through-hole 12a including one end surface 10d and penetrating the substrate main body in the thickness-wise direction, and a long groove portion 12b communicating with the through-hole 12a and extending in parallel with a main surface (for example, the lower surface 10a) of the substrate main body 101. The through-hole 12a is formed at a position corresponding to the optical waveguide 102, and an inner surface of the long groove portion 12b includes an inclined surface 12c (FIG. 4) that is in contact with the optical fiber 23a when the optical fiber 23a is inserted through the long groove portion 12b via the through-hole 12a. The through-hole 12a and the long groove portion 12b constitute an optical fiber connection portion 12 to be described later.

Here, “the through-hole 12a includes the end surface 10d” means that an edge portion of the through-hole intersects the end surface 10d in a top view. That is, the through-hole 12a is not formed at a position included in the surface of the optical waveguide substrate 10, and an inner surface of the through-hole 12a is opened at a location intersecting the end surface 10d. The optical fiber 23a engages with the open inner surface of the through-hole 12a and is aligned in the long groove portion 12b.

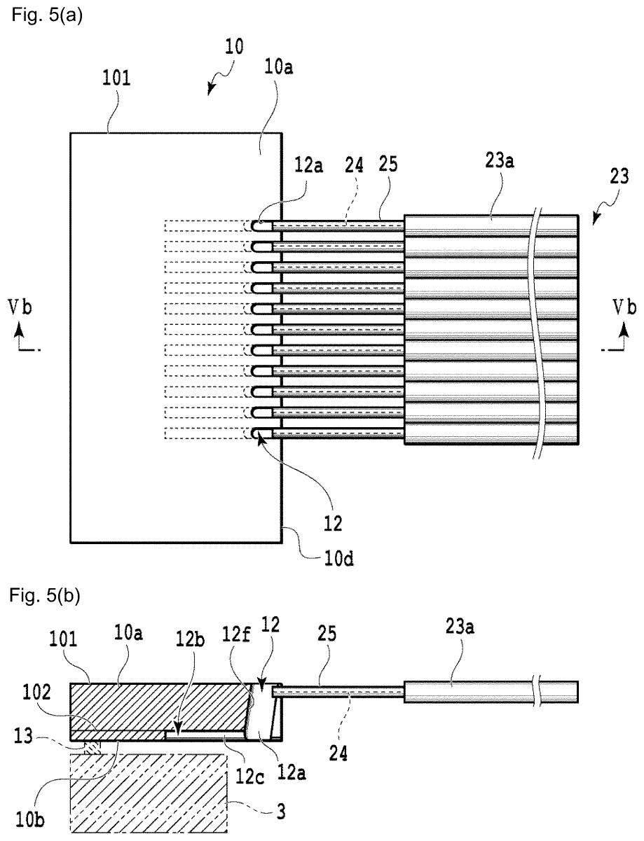

The optical waveguide substrate 10 is further connected to the optical fiber 23a and an electronic circuit 3 (FIG. 5) to constitute an optical device. According to the present embodiment, as will be described later in detail, the optical fiber 23a aligned by the through-hole 12a is connected to an unillustrated optical waveguide of the optical waveguide substrate 10 with high accuracy. Thus, the through-hole 12a is formed at a position corresponding to the unillustrated optical waveguide. Therefore, according to the present embodiment, the position of the optical waveguide can be indirectly confirmed based on the position of the through-hole 12a. A description will also be given later of this regard.

In the above-described configuration, the optical waveguide substrate 10 may be a photonic substrate made of silicon. The optical fiber 23a includes a core layer 24 serving as an optical waveguide and a cladding layer 25 for protecting the core layer 24. Each optical fiber 23a is bundled by a glass block 26 to constitute an optical fiber group 23. As shown in FIG. 2, a holding hole 26a for holding the optical fiber 23a which has been inserted through is formed in the glass block 26. The longitudinal section of the holding hole 26a has an oval shape, and the major axis thereof is designed to be larger than a value obtained by multiplying the coating diameter of the optical fiber 23a by the number of cores. The optical fibers 23a inserted through the holding holes 26a are held in parallel with each other at equal intervals. In addition, the coating is removed from a part of the optical fiber 23a on a side facing the optical waveguide substrate 10 to expose the cladding layer 25. A plurality of bumps 13 for flip-flop mounting are formed on the upper surface 10b of the optical waveguide substrate 10.

### (Optical Fiber Connection Portion)

Next, the optical fiber connection portion 12 will be described. FIGS. 4(a), 4(b), 4(c), 5(a), and 5(b) are views for illustrating the optical fiber connection portion 12. FIG. 4(a) is a top view showing the optical fiber connection portion 12 viewed from the side of the upper surface 10b of the optical waveguide substrate 10, FIG. 4(b) is a sectional view taken along arrow lines IVb, IVb in FIG. 4(a), and FIG. 4(c) is a sectional view taken along arrow lines IVc, IVc in FIG. 4(a). The long groove portion 12b has an apex angle 12e of the inclined surface and the inclined surface 12c which extends obliquely from the apex angle 12e toward the lower surface 10a of the optical waveguide substrate. The successive apexes of the apex angle 12e coincide with the center line in the extending direction of the long groove portion 12b. Therefore, it can be said that the inclined surface 12c is inclined from the center line of the long groove portion 12b in the extending direction toward the upper surface 10b (mounting surface) on which the electronic circuit 3 is mounted.

As shown in FIG. 4(c), the inclined surface 12c of the present embodiment is a V-groove having a V-shaped section orthogonal to the extending direction of the long groove portion 12b. When the optical fiber 23a is inserted through the long groove portion 12b, the optical fiber 23a comes into contact with the V-groove, is restricted from moving in the direction away from the apex angle 12e by the inclined surfaces 12c on both sides of the apex angle 12e, and is aligned with the apex angle 12e.

FIG. 5(a) is a bottom view of the optical waveguide substrate 10 viewed from the lower surface 10a, and FIG. 5(b) is a sectional view of FIG. 5(a) taken along arrow lines Vb, Vb in FIG. 5(a). Further, in FIGS. 5(a) and 5(b), a part of the optical fiber 23a enters the through-hole 12a and the optical fiber 23a is not inserted through the long groove portion 12b. As shown in FIGS. 4(a) and 5(a), an edge portion of the through-hole 12a of the present embodiment is formed in a manner of extending from the side of the end surface 10d toward the extending direction of the long groove portion 12b and drawing an arc toward the end surface 12d in a top view. Such a shape is also referred to as a “U-shape” in the present embodiment.

According to the present embodiment, as shown in FIG. 5(b), the electronic circuit 3 is mounted on the upper surface 10b of the optical waveguide substrate 10 via the bumps 13. Therefore, the upper surface 10b of the present embodiment corresponds to the mounting surface. The electronic circuit 3 is mounted before the connection and alignment of the optical fiber 23a. Therefore, according to the present embodiment, a plurality of optical fibers 23a are aligned with the through-holes 12a with respect to the optical waveguide substrate 10 on which the electronic circuit 3 has been mounted. According to the present embodiment, the electronic circuit 3 can be mounted in a state in which the optical fibers 23a are not connected, and the mounting of the electronic circuit 3 is facilitated.

As shown in FIG. 5(b), a slope 12f is formed on an inner surface of the through-hole 12a in a manner of being inclined from the apexes of the apex angle 12c, that is, the center line in the extending direction of the long groove portion 12b toward the upper surface 10b which is the mounting surface. The slope 12f has a function of contacting the optical fiber 23a and smoothly guiding the optical fiber 23a to a lower portion of the through-hole 12a following the long groove portion 12b when the optical fibers 23a aligned at equal intervals and in parallel by the through-holes 12a move downward. As shown in FIG. 5(c), the long groove portion 12b is formed at a position corresponding to the optical waveguide 102. The optical fiber 23a guided to the lower side of the through-hole 12a advances along the long groove portion 12b, and the end surface of the optical fiber is aligned with the end surface of the optical waveguide 102. Further, “the position where the long groove portion 12b and the optical waveguide 102 correspond to each other” refers to a position where an optical axis of the optical fiber 23a inserted through the long groove portion 12b and an optical axis of the optical waveguide 102 coincide with each other in this way.

The V-shaped long groove portion 12b can be formed by photolithography and wet etching, which are known. The long groove portion 12b is formed in accordance with the position of the optical waveguide 102. The depth of the long groove portion 12b is adjusted so that the center of the core layer 24 of the optical fiber 23a coincides with the height of the optical waveguide 102. According to the present embodiment, disposing the optical fiber 23a in the V-groove of the long groove portion 12b makes it possible to establish a low-loss optical connection while omitting the optical polishing process and the active alignment process.

### (Method for Manufacturing Optical Device)

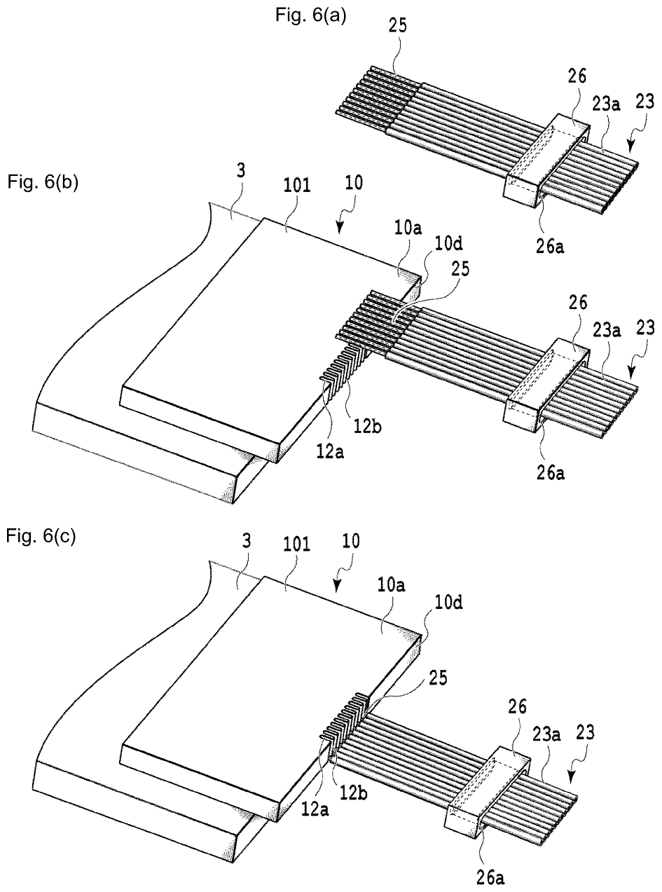

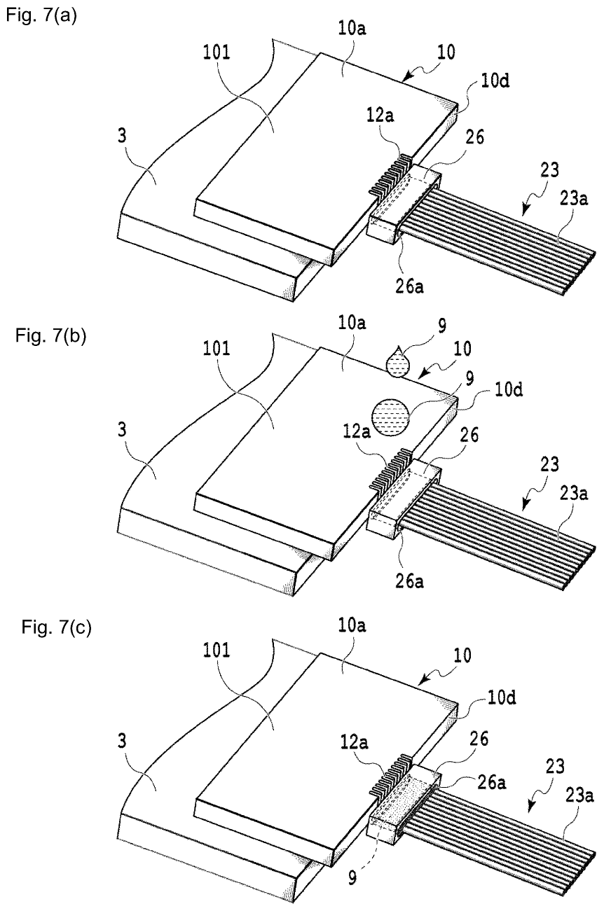

Next, a method for manufacturing the above-described optical device 100 will be described. FIGS. 6(a), 6(b), 6(c), 7(a), 7(b), and 7(c) are views for describing individual processes of manufacturing the optical device 100. In the method for manufacturing the optical device 100 according to the present embodiment, first, as shown in FIG. 6(a), a plurality of optical fibers 23a are passed through the holding holes 26a of the glass block 26 to form the optical fiber group 23. At this time, a part of the optical fiber 23a facing the optical waveguide substrate 10 is subjected to coating material removal and cleave cutting. Next, as shown in FIG. 6(b), the distal ends of the optical fiber group 23 are slidably inserted into the through-holes 12a from above, and are aligned at equal intervals. Further, as shown in FIGS. 6(b) and 6(c), the electronic circuit 3 is already mounted on the upper surface 10b.

At this time, the through-hole 12a has a relatively gentle U-shape, and thus, when the optical fiber 23a is pushed toward the long groove portion 12b, the position in the horizontal direction is regulated by the through-hole 12a, and the alignment in the horizontal direction becomes possible. Further, as shown in FIG. 6(c), the optical fiber 23a moves in the optical waveguide substrate 10 downward. The apex of the convex portion of the U-shaped portion of the through-hole 12a coincides with the apex of the apex angle 12e of the long groove portion 12b in a planar direction of the optical waveguide substrate 10. Therefore, the optical fiber 23a moved downward smoothly descends toward the apex angle of the V-shaped groove while contacting the inner surface of the through-hole 12a. At this time, as described above, the optical fiber 23a slides on the slope 12f provided on the inner surface of the through-hole 12a, and then is smoothly loaded into the long groove portion 12b. According to the above-described processes, the method for manufacturing the optical device of the present embodiment enables the optical fiber 23a and the optical waveguide to be aligned in the horizontal direction.

According to the present embodiment, when the optical fiber 23a is pushed toward the long groove portion 12b, the optical fiber 23a may be inclined at an angle in a range of one degree to ten degrees inclusive with respect to the lower surface 10a of the optical waveguide substrate 10. At this time, it is preferable that the inclination of the optical fiber 23a is such that the optical fiber 23a faces upward from the lower surface 10a, that is, forms an elevation angle. This contributes to enhancing the adhesion of the optical fiber 23a to the inner surface of the long groove portion 12b and reducing the optical loss.

FIG. 7(a) shows a state in which the glass block 26 is brought close to the end surface 10d of the optical waveguide substrate 10 after the optical fiber 23a is loaded. In such a state, according to the present embodiment, when the optical waveguide substrate 10 is viewed from the lower surface 10a to which the electronic circuit 3 is not bonded, the position of the optical waveguide can be confirmed based on the position of the through-hole 12a.

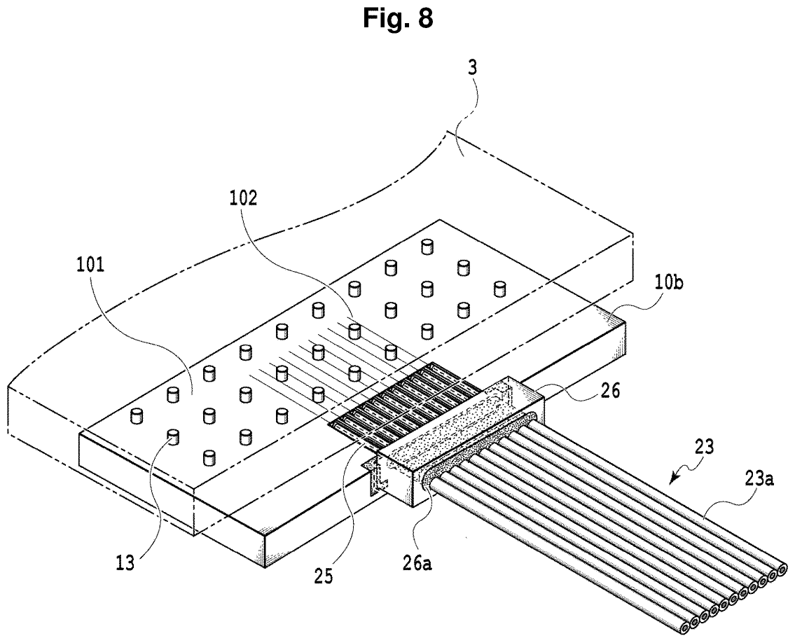

Next, according to the present embodiment, as shown in FIG. 7(b), an ultraviolet (UV) curable adhesive 9 is dripped into the holding hole 26a of the glass block 26 and fixed by irradiating an appropriate amount of ultraviolet rays. The ultraviolet curable adhesive is filled in all the through-holes 12a and all the long groove portions 12b to firmly fix the optical fiber 23a to the optical waveguide substrate 10. FIG. 7(c) shows a state in which all the holding holes 26a of the glass block 26 are filled with the ultraviolet curable adhesive 9. FIG. 8 shows a state in which the optical device shown in FIG. 7(b) is viewed from the side on which the electronic circuit 3 is mounted, that is, from the upper surface 10b.

As described above, according to the present embodiment, by providing the through-hole 12a and the long groove portion 12b, it is possible to align the optical fiber with the optical waveguide of the optical waveguide substrate at an appropriate angle. Therefore, according to the present embodiment, the accuracy of the rough alignment between the optical waveguide and the optical fiber 23a can be enhanced as compared with in the known technique, and thus, the time required for aligning or polishing the optical waveguide and the optical fiber end surface can be shortened. In addition, since the through-hole 12a is formed in accordance with the position of the optical fiber to be aligned with the optical waveguide, the through-hole 12a is inevitably formed at a position corresponding to the optical waveguide. Therefore, according to the present embodiment, the position of the optical waveguide can be confirmed from the side of the lower surface 10a of the optical device, and the operation of aligning and connecting the optical fiber 23a can be facilitated. The operation of aligning and connecting the optical fiber 23a may be performed manually by an operator. Further, the operation may be controlled automatically by a robot or the like, or may be controlled by an operator watching a monitor or the like.

### REFERENCE SIGNS LIST

10 Optical waveguide substrate
12a Through-hole
12b Long groove portion
12c Inclined surface
12d End surface
12e Apex angle
12f Slope
13 Bump
23 Optical fiber group
23a Optical fiber
24 Core layer
25 Cladding layer
26 Glass block
26a Holding hole
100 Optical device
101 Substrate main body
102 Optical waveguide

1. An optical waveguide substrate comprising: a substrate main body; and an optical waveguide formed in the substrate main body,
the substrate main body including a through-hole which includes one end surface of the substrate main body and penetrates the substrate main body in a thickness-wise direction, and a long groove portion which communicates with the through-hole and extends in parallel with a main surface of the substrate main body,
the through-hole being formed at a position corresponding to the optical waveguide, and
an inner surface of the long groove portion including an inclined surface which is in contact with an optical fiber when the optical fiber is inserted through the long groove portion via the through-hole.

2. The optical waveguide substrate according to claim 1, wherein the inclined surface of the long groove portion is a V-shaped groove having a V-shaped section which is orthogonal to an extending direction of the long groove portion.

3. The optical waveguide substrate according to claim 1, wherein a shape of the through-hole in a top view includes a U-shaped portion which protrudes from the end surface of the substrate main body toward the extending direction of the long groove portion.

4. An optical device comprising:
the optical waveguide substrate according to claim 1; and
an electronic circuit mounted on a mounting surface which is a main surface of the optical waveguide substrate,
the inclined surface of the through-hole being inclined toward the mounting surface from a center line which is in the extending direction of the long groove portion.

5. The optical device according to claim 4, further comprising a plurality of optical fibers inserted through the long groove portion via the through-hole.

6. A method for manufacturing an optical device that includes an optical waveguide substrate including a substrate main body and an optical waveguide formed on the substrate main body, and a plurality of optical fibers aligned and connected to the optical waveguide,
the substrate main body including a through-hole which includes one end surface of the substrate main body and penetrates the substrate main body in a thickness-wise direction, and a long groove portion which communicates with the through-hole and extends in parallel with a main surface of the substrate main body,
the method comprising:
aligning the plurality of optical fibers with the through-hole;
translating the plurality of optical fibers aligned, along the long groove portion; and
fixing the plurality of optical fibers inside the long groove portion.

7. The method according to claim 6, wherein the plurality of optical fibers are fixed to and aligned with a fixing block.

8. The method according to claim 6, wherein the optical fibers form an elevation angle in a range of one degree to ten degrees inclusive with respect to a surface direction of the optical waveguide substrate when the optical fibers are translated along the long groove portion.

9. The method according to claim 6, wherein the plurality of optical fibers are aligned with the through-hole with respect to the optical waveguide substrate on which an electronic circuit has been mounted.

10. The optical waveguide substrate according to claim 2, wherein a shape of the through-hole in a top view includes a U-shaped portion which protrudes from the end surface of the substrate main body toward the extending direction of the long groove portion.

11. An optical device comprising:
the optical waveguide substrate according to claim 2; and
an electronic circuit mounted on a mounting surface which is a main surface of the optical waveguide substrate,
the inclined surface of the through-hole being inclined toward the mounting surface from a center line which is in the extending direction of the long groove portion.

12. An optical device comprising:
the optical waveguide substrate according to claim 3; and
an electronic circuit mounted on a mounting surface which is a main surface of the optical waveguide substrate,
the inclined surface of the through-hole being inclined toward the mounting surface from a center line which is in the extending direction of the long groove portion.

13. The method according to claim 7, wherein the optical fibers form an elevation angle in a range of one degree to ten degrees inclusive with respect to a surface direction of the optical waveguide substrate when the optical fibers are translated along the long groove portion.

14. The method according to claim 7, wherein the plurality of optical fibers are aligned with the through-hole with respect to the optical waveguide substrate on which an electronic circuit has been mounted.

15. The method according to claim 8, wherein the plurality of optical fibers are aligned with the through-hole with respect to the optical waveguide substrate on which an electronic circuit has been mounted.
